(19) United States
(12) Patent Application Publication
(10) Pub. No.: US 2018/0112460 A1
(43) Pub. Date: Apr. 26, 2018

(54) LADDER TAPE AND WINDOW BLIND WITH THE SAME

(71) Applicant: NIEN MADE ENTERPRISE CO., LTD., Taichung (TW)

(72) Inventors: YUNG-CHIEH HUANG, Changhua County (TW); KENG-HAO NIEN, Taichung City (TW)

(21) Appl. No.: 15/477,726

(22) Filed: Apr. 3, 2017

(30) Foreign Application Priority Data
Oct. 21, 2016 (CN) 201621144471.0

(51) Int. Cl. E06B 9/303; E06B 9/323

(52) U.S. Cl. CPC E06B 9/303; E06B 9/30; E06B 9/323

(57) ABSTRACT

A window blind includes a headrail, a bottom rail, a plurality of slats horizontally provided therebetween, a ladder tape connecting the headrail and the bottom rail, and at least one cord adapted to collect and expand the blind. The ladder tape includes a first vertical member and a second vertical member which are provided in parallel, with a space left therebetween. The second vertical member is a piece of fabric made by interweaving multiple first vertical yarns and multiple first horizontal yarns. Multiple ring members are provided in a longitudinal axial direction of at least one of the first vertical member and the second vertical member. Since the aforementioned vertical components and loop segments are made by weaving, these components are prevented from being pulled out to form loops. The position of the cord is restricted to avoid excessive horizontal movement and the hazard of wrapping around human body parts.

### BACKGROUND OF THE INVENTION

### 1. Technical Field

The present disclosure relates generally to a window blind, and more particularly to a ladder tape and a window blind with said composite ladder tape.

### 2. Description of Related Art

The structure of a conventional window blind commonly includes a headrail, a bottom rail, and a plurality of slats horizontally arranged therebetween, wherein the headrail and the bottom rail are connected through ladder tapes. Each ladder tape includes two warps and a plurality of wefts. The warps are respectively provided on the front and rear sides of the slats, wherein two ends of the warps are respectively connected to the headrail and the bottom rail. Two ends of each weft are respectively connected to one warp in a way that the wefts are arranged between two warps, and an interval existing between each two neighboring warps to allow one of the slats to rest thereon. When one of the warps is moved up and down relative to the other warp, the wefts tilt, so that the slats rest thereon are tilted as well. In this way, the slats can be rotated to a closed position.

In some conventional window blinds, pieces of wide fabric are further provided between the headrail and the bottom rail to create a decorative effect. In addition, the pieces of wide fabric could properly conceal the through holes on the slats, the warps of the ladder tapes, and control cords. However, the pieces of fabric, the warps, and the cords are independent components, and therefore loops of different sizes may be formed therebetween during the operation of the window blind to cause annoying knots. Furthermore, some loops in larger size may even wrap around human body parts while the cords and pieces of fabric are pulled outward from the blind, which is very dangerous.

### BRIEF SUMMARY OF THE INVENTION

In view of the above, the primary objective of the present disclosure is to provide a ladder tape and a window blind with said ladder tape, which has simplified and practical structure, and would have a lower risk of forming hazardous loops. Whereby, the safety in use could be improved.

The ladder tape includes a first vertical member, a second vertical member, a plurality of connectors, and a plurality of ring members. The second vertical member is arranged in parallel with the first vertical member, and is spaced apart from the first vertical member by a distance, wherein the second vertical member is a piece of fabric made by interweaving a plurality of first vertical yarns and a plurality of first horizontal yarns. Each of the connectors respectively joins the first vertical member and the second vertical member with two ends thereof. The ring members are provided in a longitudinal axial direction of at least one of the first vertical member and the second vertical member.

In an embodiment, the first vertical member includes a first warp yarn, and the second vertical member includes a second warp yarn. The ring members include a plurality of first loop segments, wherein the first loop segments are formed by one of the first warp yarn and the second warp yarn.

In an embodiment, the ring members include a plurality of second loop segments, and the second loop segments are formed by the other one of the first warp yarn and the second warp yarn.

In an embodiment, the connectors include a plurality of first bridge segments provided from the first warp yarn. Each of the first bridge segments respectively joins the first vertical member and the second vertical member with two ends thereof, and each of the first bridge segments is spaced apart from an adjacent one of the first bridge segments by a distance between the first vertical member and the second vertical member.

In an embodiment, the connectors include a plurality of second bridge segments provided from the second warp yarn. Each of the second bridge segments respectively joins the second vertical member and the first vertical member with two ends thereof, and each of the second bridge segments is spaced apart from an adjacent one of the second bridge segments by a distance between the second vertical member and the first vertical member.

In an embodiment, the first vertical member includes a third warp yarn, and the connectors include a plurality of first bridge segments provided from the third warp yarn. Each of the first bridge segments respectively joins the first vertical member and the second vertical member with two ends thereof, and each of the first bridge segments is spaced apart from an adjacent first bridge segments by a distance between the first vertical member and the second vertical member.

In an embodiment, the second vertical member includes a fourth warp yarn, and the connectors include a plurality of second bridge segments provided from the fourth warp yarn. Each of the second bridge segments respectively joins the second vertical member and the first vertical member with two ends thereof, and each of the second bridge segments is spaced apart from an adjacent one of the second bridge segments by a distance between the second vertical member and the first vertical member.

In an embodiment, the first vertical member is a cord spaced apart from the second vertical member.

In an embodiment, the first vertical member is a piece of fabric made by interweaving a plurality of second vertical yarns and a plurality of second horizontal yarns.

In an embodiment, a width of the first vertical member and a width of the second vertical member are equal.

In an embodiment, a width of the first vertical member and a width of the second vertical member are different from each other.

The window blind includes a headrail, a bottom rail, a plurality of slats horizontally provided between the headrail and the bottom rail, a ladder tape, and at least one cord, wherein the headrail and the bottom rail are connected by the ladder tape; the at least one cord is adapted to collect and expand the window blind. The ladder tape includes a first vertical member, a second vertical member, a plurality of connectors, and a plurality of ring members. The second vertical member is arranged in parallel with the first vertical member, and is spaced apart from the first vertical member by a distance, wherein the second vertical member is a piece of fabric made by interweaving a plurality of first vertical yarns and a plurality of first horizontal yarns. Each of the connectors respectively joins the first vertical member and the second vertical member with two ends thereof. The ring members are provided in a longitudinal axial direction of at least one of the first vertical member and the second vertical member.

In an embodiment, the first vertical member includes a first warp yarn, and the second vertical member includes a second warp yarn. The ring members include a plurality of first loop segments, wherein the first loop segments are formed by one of the first warp yarn and the second warp yarn. The at least one cord includes a first cord passing through the first loop segments.

In an embodiment, the ring members include a plurality of second loop segments, and the second loop segments are formed by the other one of the first warp yarn and the second warp yarn. The at least one cord includes a second cord passing through the second loop segments.

In an embodiment, each of the slats is provided with a through hole. The first cord passes through the first loop segments, wherein the first loop segments respectively pass through the through holes of the slats, and a portion of each of the first loop segments coming out from the corresponding through hole is passed through by the first cord.

In an embodiment, each of the slats is provided with a through hole. The second cord passes through the second loop segments, wherein the second loop segments respectively pass through the through holes of the slats, and a portion of each of the second loop segments coming out from the corresponding through hole is passed through by the second cord.

In an embodiment, the connectors include a plurality of first bridge segments provided from the first warp yarn. Each of the first bridge segments respectively joins the first vertical member and the second vertical member with two ends thereof, and each of the first bridge segments is spaced apart from an adjacent one of the first bridge segments by a distance between the first vertical member and the second vertical member. Each of the first bridge segments has one of the slats resting thereon.

In an embodiment, the connectors include a plurality of second bridge segments provided from the second warp yarn. Each of the second bridge segments respectively joins the second vertical member and the first vertical member with two ends thereof, and each of the second bridge segments is spaced apart from an adjacent one of the second bridge segments by a distance between the second vertical member and the first vertical member. Each of the second bridge segments has one of the slats resting thereon.

In an embodiment, the first vertical member includes a third warp yarn, and the connectors include a plurality of first bridge segments provided from the third warp yarn. Each of the first bridge segments respectively joins the first vertical member and the second vertical member with two ends thereof, and each of the first bridge segments is spaced apart from an adjacent first bridge segments by a distance between the first vertical member and the second vertical member. Each of the first bridge segments has one of the slats resting thereon.

In an embodiment, the second vertical member includes a fourth warp yarn, and the connectors include a plurality of second bridge segments provided from the fourth warp yarn. Each of the second bridge segments respectively joins the second vertical member and the first vertical member with two ends thereof, and each of the second bridge segments is spaced apart from an adjacent one of the second bridge segments by a distance between the second vertical member and the first vertical member. Each of the second bridge segments has one of the slats resting thereon.

In an embodiment, the first vertical member is a cord spaced apart from the second vertical member.

In an embodiment, the first vertical member is a piece of fabric made by interweaving a plurality of second vertical yarns and a plurality of second horizontal yarns.

In an embodiment, a width of the first vertical member and a width of the second vertical member are equal.

In an embodiment, a width of the first vertical member and a width of the second vertical member are different from each other.

Since the pieces of fabric and the loop segments are made at the same time, related components could be prevented from being pulled outward to form loops. Furthermore, the positions of the cords could be effectively restricted, whereby the cords could be avoided from being moved horizontally to a great extent. Therefore, the ladder tape and the window blind provided in the present disclosure could be neat and beautiful, and could improve the safety in use.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a perspective view of a window blind of a first embodiment of the present disclosure, which has a ladder tape;

FIG. 2 is a partial perspective view of the ladder tape of the first embodiment;

FIG. 3 is a schematic view showing the structure of a piece of fabric and a cord of the ladder tape of the first embodiment;

FIG. 4 is a partial enlarged schematic view showing the structure of the piece of fabric and cord of the ladder tape of the first embodiment;

FIG. 5 is a partial enlarged view of the ladder tape of the first embodiment;

FIG. 6 is a partial enlarged schematic view showing the structure of a piece of fabric and a cord of the ladder tape of another embodiment;

FIG. 7 is a partial enlarged schematic view showing the structure of a piece of fabric of a ladder tape of a second embodiment; and

FIG. 8 is a partial enlarged schematic view showing the structure of a piece of fabric of a ladder tape of a third embodiment.

### DETAILED DESCRIPTION OF THE INVENTION

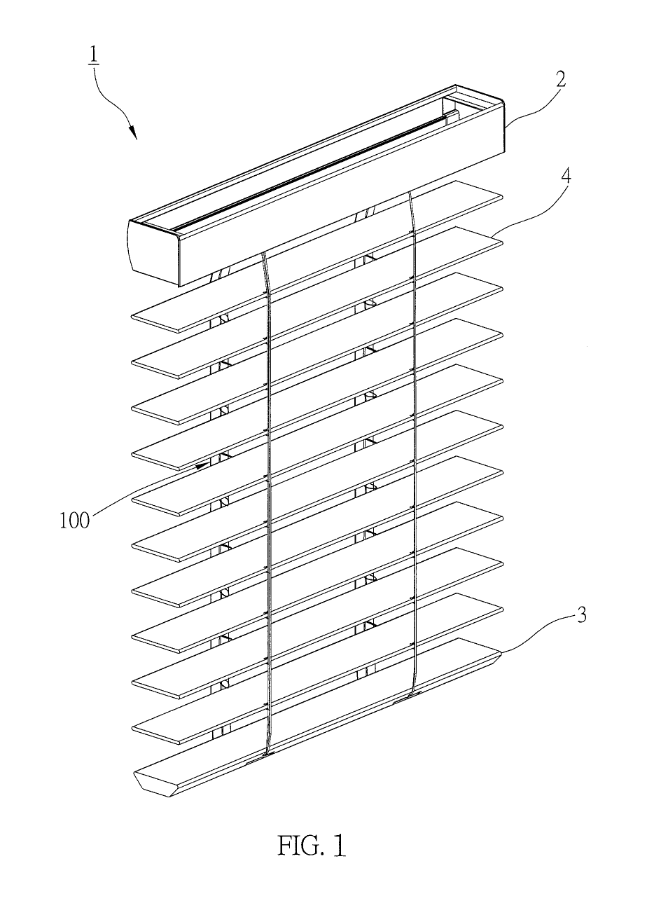

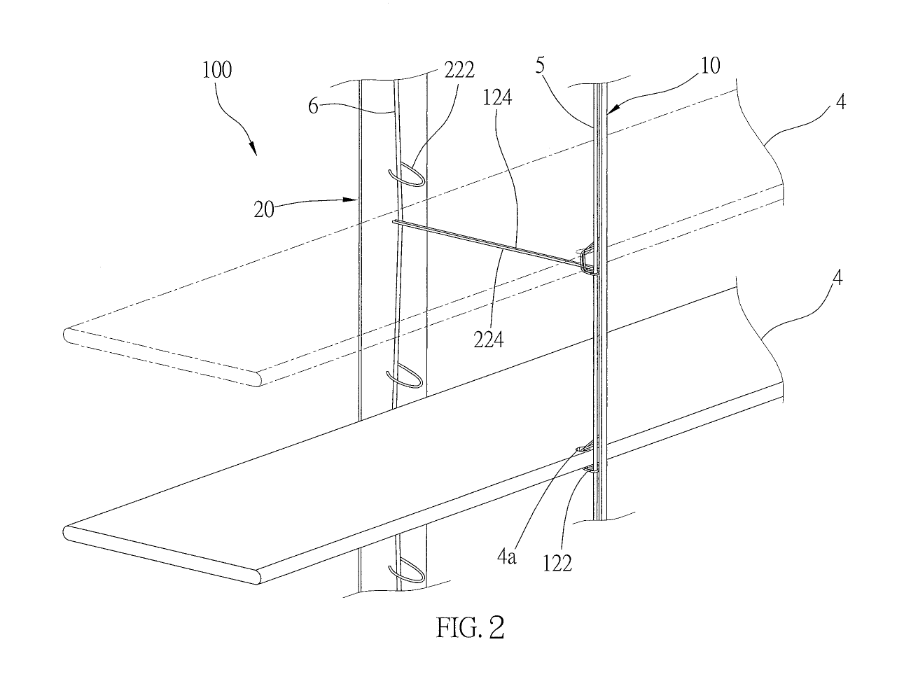

As shown in FIG. 1 and FIG. 2, a window blind 1 of the first embodiment of the present disclosure has a ladder tape 100, and further includes a headrail 2, a bottom rail 3, a plurality of slats 4 provided between the headrail 2 and the bottom rail 3, at least one first cord 5, and at least one second cord 6. The at least one first cord 5 and the at least one second cord 6 are respectively provided on a front side and a rear side of the slats 4, and engaged with the bottom rail 3, whereby to form at least one pulling cord, which is adapted to collect and to expand the window blind. Alternatively, the at least one first cord 5 and the at least one second cord 6 could be mutually connected in the bottom rail 3. The headrail 2 and the bottom rail 3 are connected by a ladder tape 100. The ladder tape 100 includes a first vertical member, a second vertical member, a plurality of connectors, and a plurality of ring members, wherein the first vertical member and the second vertical member are provided in parallel. Two ends of the first vertical member and the second vertical member are respectively connected to the headrail 2 and the bottom rail 3. Each of the connectors respectively joins the first vertical member and the second vertical member with two ends thereof. The ring members are arranged in a longitudinal axial direction of at least one of the first vertical member and the second vertical member.

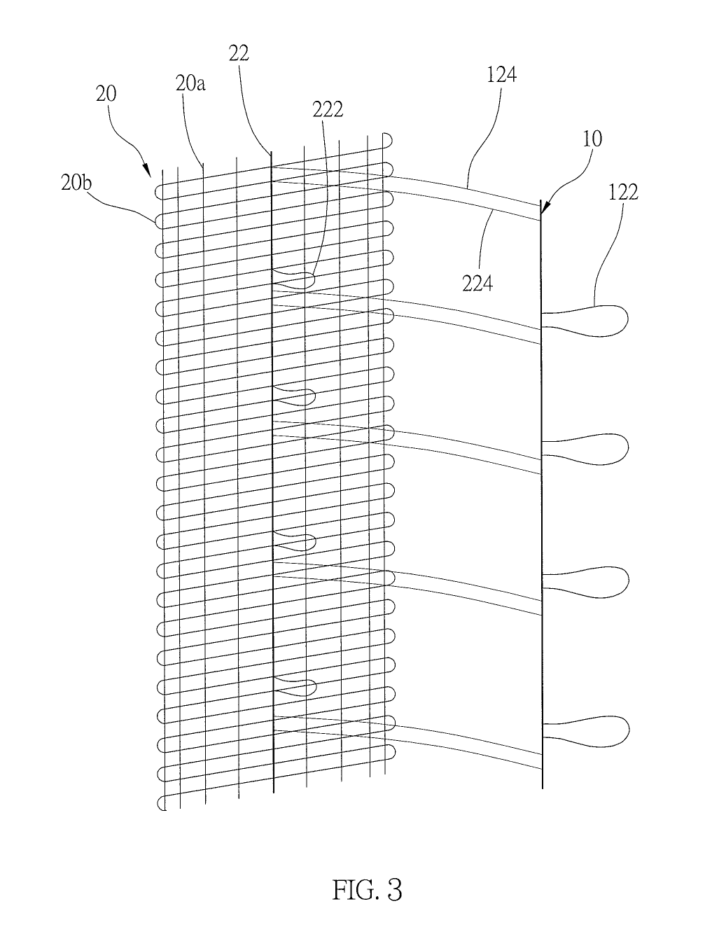

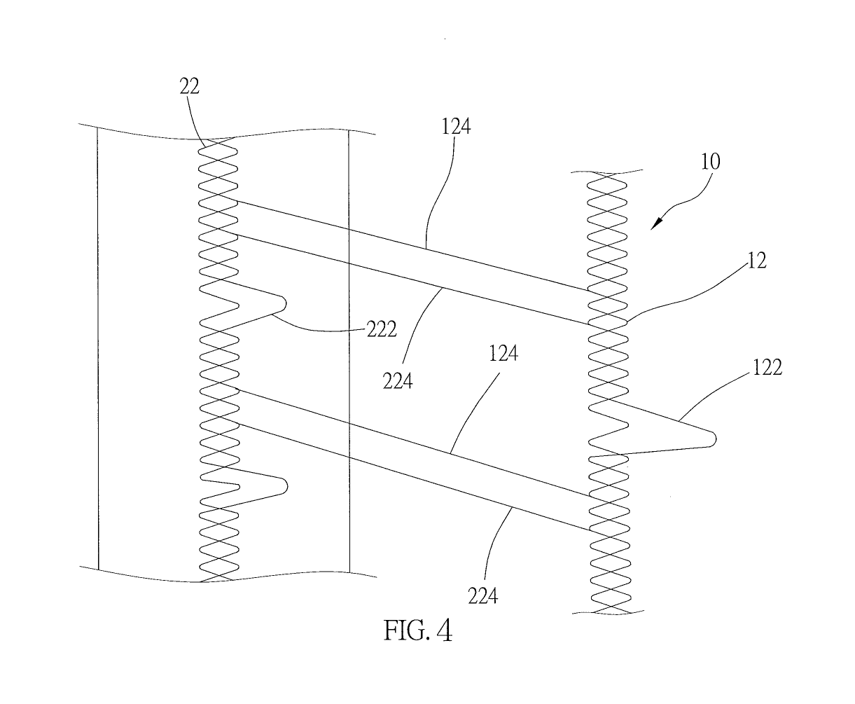

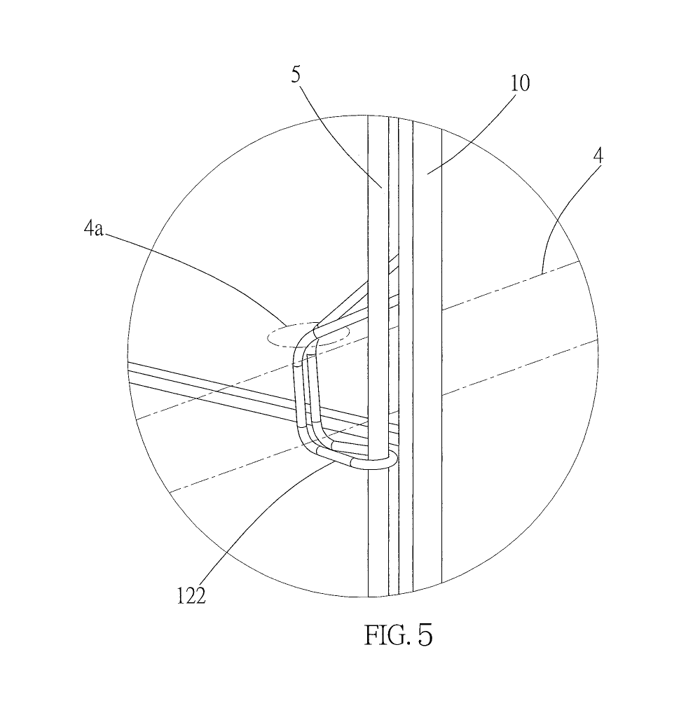

As shown in FIG. 2 to FIG. 4, the first vertical member is a cord 10, and the ring members includes a plurality of first loop segments 122 arranged in the longitudinal axial direction of the cord 10, wherein each of the first loop segments is spaced apart from an adjacent one of the first loop segments by a distance. In the first embodiment, the cord 10 is made by interweaving a plurality of warp yarns. Among the warp yarns of the cord 10, a first warp yarn 12 is included, wherein the first loop segments 122 are provided from the first warp yarn 12. Specifically, the first loop segments 122 are arranged in the longitudinal axial direction of the thin cord 10, each of which is spaced apart from an adjacent one by a distance. The first loop segments 122 are adapted to be passed through by the first cord 5, whereby the movable range and the position of the first cord 5 could be adequately restricted and positioned. Preferably, a through hole 4a is provided at a lateral edge of each of the slats 4 in an embodiment. The first cord 5 passed through the first loop segments 122. In more details, each of the first loop segments 122 passes through the through hole 4a on one of the slats 4, and a portion of each of the first loop segments 122 coming out from the corresponding through hole 4a is passed through by the first cord 5, as shown in FIG. 5.

In addition, said connectors include a plurality of first bridge segments. In the first embodiment, the first bridge segments 124 are provided from the first warp yarn 12, wherein each of the first bridge segments 124 respectively joins the thin cord 10 and the second vertical member with two ends thereof, whereby to be arranged between the cord 10 and the second vertical member. In more details, each of the first bridge segments 124 is spaced apart from an adjacent one of the first bridge segments 124 by a distance, and each of the first bridge segments 124 is adapted to have one of the slats 4 resting thereon.

The second vertical member and the first vertical member are provided in parallel, and are spaced apart from each other by a distance. In the first embodiment, the second vertical member is a piece of fabric 20. The ring members include a plurality of second loop segments provided in the longitudinal axial direction of the piece of fabric 20, wherein each of the second loop segments is spaced apart from an adjacent one of the second loop segments by a distance. In the first embodiment, the piece of fabric 20 is made by interweaving a plurality of first vertical yarns 20a and a plurality of first horizontal yarns 20b, wherein the first vertical yarns 20a are provided in the longitudinal axial direction of the piece of fabric 20, and the first horizontal yarns 20b are provided in a direction perpendicular to the longitudinal axial direction of the piece of fabric 20. Furthermore, among the first vertical yarns 20a, a second warp yarn 22 is included. However, the second warp yarn 22 is not limited to be one of the first vertical yarns in other embodiments, and it could be a thin cord formed by the first vertical yarns or other yarn materials. The arrangement in the first embodiment (i.e., the second warp yarn is one of the first vertical yarns) is taken as an example herein. During the process of making the first vertical yarns 20a, the second warp yarn 22 is pulled out from the woven structure of the piece of fabric 20, so that the second loop segments 222 are provided from the second warp yarn 22 in the longitudinal axial direction of the piece of fabric 20, wherein each of the second loop segments 222 is spaced apart from an adjacent one of the second loop segments 222 by a distance. The second loop segments 222 are adapted to be passed through by the second cord 6, whereby the movable range and the positions of the second cord 6 could be adequately restricted and positioned. Similar to the first loop segments 122 shown in FIG. 5, the second cord 6 passes through the second loop segments 222. In more details, each of the second loop segments 222 passes through the through hole 4a of one of the slats 4, and a portion of each of the second loop segments 222 coming out from the corresponding through hole 4a is passed through by the second cord 6. In addition, the first loop segments 122 and the second loop segments could be exchanged against each other in another embodiment. In other words, the second loop segments are provided from the first warp yarn, and the first loop segments are provided from the second warp yarn. Alternatively, there could be only either the first loop segments or the second loop segments provided on the cord or the piece of fabric.

In addition, in another embodiment, said connectors include a plurality of second bridge segments. For example, the second warp yarn 22 forms the second bridge segments 224, wherein each of the second bridge segments 224 respectively joins the piece of fabric 20 and the thin cord 10 with two ends thereof. In other words, the second bridge segments 224 are provided between the piece of fabric 20 and the cord 10, and each of the second bridge segments 224 is spaced apart from an adjacent one of the second bridge segments 224 by a distance, wherein each of the second bridge segment 224 is adapted to have one of the slats 4 resting thereon. In an embodiment, two adjacent first bridge segment 124 and second bridge segment 224 could be either vertically arranged or located at a similar height between the piece of fabric 20 and the cord 10, so that the same slat 4 could rest thereon. In an embodiment, when the adjacent first bridge segment 124 and second bridge segment 224 are vertically arranged between the piece of fabric 20 and the cord 10, one of the slats 4 could be placed into a receiving space formed between said adjacent first bridge segment 124 and second bridge segment 224.

In the aforementioned design, the first loop segments 122 (or the second loop segments 222) and the first warp yarn 12 are simultaneously made in the cord 10. Furthermore, the first cord 5, the cord 10, and the slats 4 would restrict each other to confine a horizontal movable range of the first cord 5 due to the cooperation of the first loop segments 122 and the through holes 4a of the slats 4. Therefore, these components would not be easily disengaged or excessively shifted. In this way, even if the first cord 5 is vigorously pulled, it would not be pulled outward to form a loop, which could lower the risk of causing injuries by wrapping around human body parts.

Furthermore, the piece of fabric 20, the second warp yarn 22, and the second loop segments 222 (or the first loop segment 122) could be simultaneously made as well. Whereby, these components could be prevented from being pulled outward to form loops. In addition, since the second cord 6 is confined by the second loop segments 222 in predetermined intervals, the second cord 6 would not be easily pulled outward to form a loop while being vigorously pulled. In this way, the second cord 6 would be unlikely to wrap around human body parts, and therefore the risk of causing injuries could be lowered.

The advantage of providing the through holes 4a at the lateral edges of the slats 4 is that, when the window blind is fully closed, each of the through holes 4a could be concealed by an overlapping portion of the adjacent slat 4, whereby the through holes 4a would not be exposed, which could improve the beauty and concealment of the window blind.

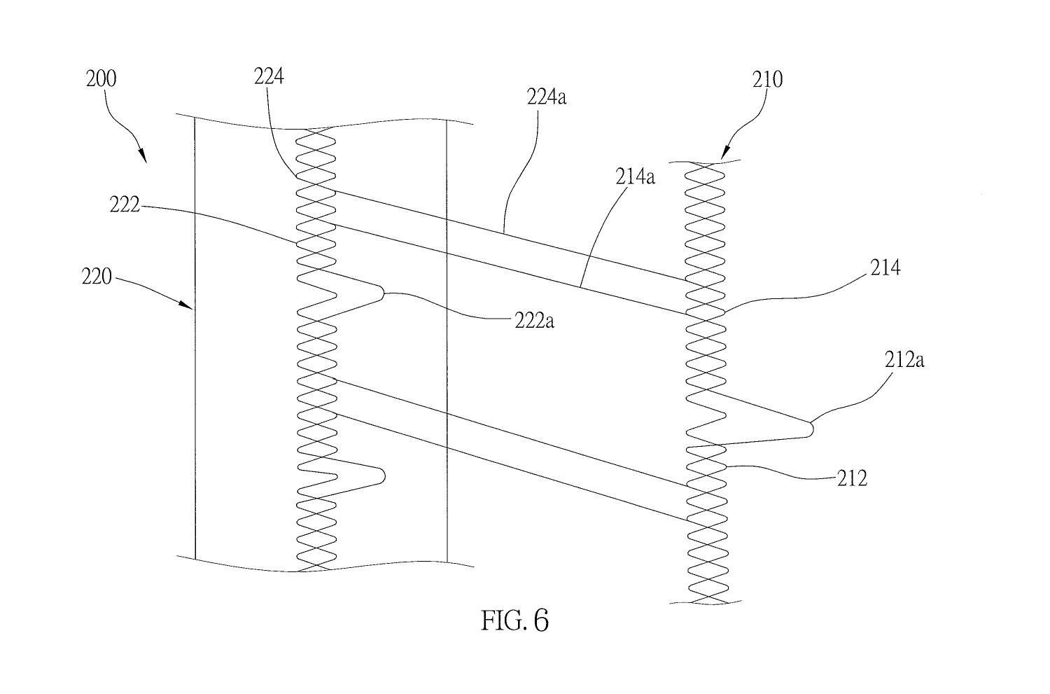

It is worth mentioning that, the loop segments and the bridge segments provided from the second warp yarn may be integrally made in one piece while weaving the second warp yarn to form the structure of the piece of fabric. Similarly, the loop segments and the bridge segments provided from the first warp yarn may be integrally made in one piece as well while weaving the first warp yarn to form the cord. In another embodiment, the loop segments and the bridge segments can be constructed from different warp yarns. A ladder tape 200 of another embodiment is illustrated in FIG. 6. The ladder tape 100 of the aforementioned window blind 1 could be replaced by the ladder tape 200. The differences between the ladder tape 200 and the ladder tape 100 include:

In addition to including a first warp yarn 212 which forms a plurality of first loop segments 212a, a cord 210 of the ladder tape 200 further includes a third warp yarn 214. Said connectors include a plurality of first bridge segments 214a provided from the third warp yarn 214, wherein each of the first bridge segments 214a respectively joins the thin cord 210 and a piece of fabric 220 of the ladder tape 200 with two ends thereof. Similarly, the first bridge segments 214a are arranged in a way that each of the first bridge segments 214a is spaced apart from an adjacent one of the first bridge segments 214a by a distance, and each of the first bridge segments 214a is adapted to have one of the slats resting thereon.

In addition to including a second warp yarn 222 which forms a plurality of second loop segments 222a, vertical yarns of the piece of fabric 220 further include a fourth warp yarn 224. Said connectors include a plurality of second bridge segments 224a provided from the fourth warp yarn 224. Each of the second bridge segments 224a respectively joins the piece of fabric 220 and the thin cord 210 with two ends thereof. Similarly, each of the second bridge segments 224a is spaced apart from an adjacent one of the second bridge segments 224a by a distance between the piece of fabric 220 and the cord 210, and each of the second bridge segments 224a is adapted to have one of the slats resting thereon.

In other words, the differences between the ladder tape 200 and the ladder tape 100 in the previous embodiment are that, for the ladder tape 200, the first loop segments 212a thereof and the first bridge segments 214a thereof are respectively formed from the first warp yarn 212 and the third warp yarn 214; the second loop segments 222a thereof and the second bridge segments 224a thereof are respectively formed from the second warp yarn 222 and the fourth warp yarn 224.

During the process of making the ladder tape, every time each of warp yarns is processed to an appropriate position, it would be pulled outward to integrally form a loop segment or a bridge segment. In other words, either or both of the loop segments and the bridge segments could be integrally formed by pulling out one warp yarn at a designated position. In this way, the structure of each independent component in the window blind could be effectively simplified. Furthermore, the positions of the first cord and the second cord could be properly confined, which could prevent the cords from being moved in a horizontal direction to a great extent, or being pulled outward to form a loop. As a result, the safety of the window blind in use could be improved. In addition, the bridge segments are adapted to bear the slats.

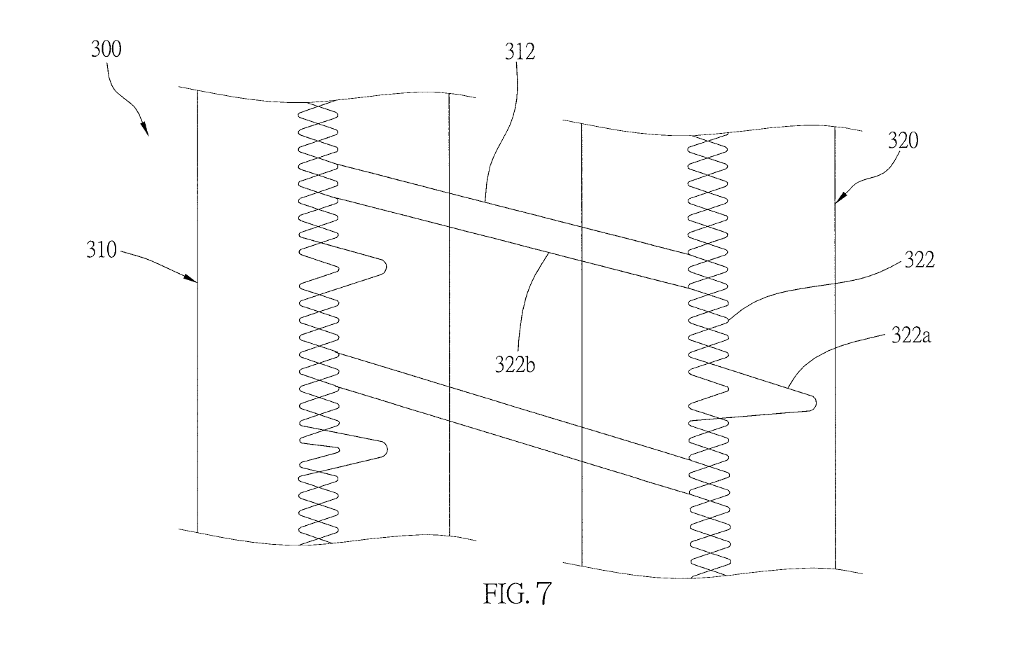

It is worth mentioning that, though there is only one piece of fabric and one cord included in each of the previous embodiments, the number of the piece of fabric is not limited to one in practice. For example, a ladder tape 300 of a second embodiment of the present disclosure illustrated in FIG. 7 is different from the ladder tape in each of the previous embodiments. A first vertical member and a second vertical member of the ladder tape 300 are both pieces of fabric, wherein the second vertical member is defined as a first piece of fabric 310, while the first vertical member is defined as a second piece of fabric 320. The composition of the first piece of fabric 310 is approximately the same as that of the piece of fabric in each embodiment mentioned above. However, this is not a limitation of the present disclosure. The first piece of fabric 310 could be made of different yarn materials in different weaving methods. In addition, the second piece of fabric 320 and the first piece of fabric 310 could have the same or different compositions. In the current embodiment, the first piece of fabric 310 is roughly the same as the piece of fabric in the previous embodiments. The weaving structure of the first piece of fabric 310 includes a second warp yarn, which forms a plurality of second bridge segments 312, wherein each of the second bridge segments 312 respectively joins the first piece of fabric 310 and the second piece of fabric 320 with two ends thereof. Furthermore, each of the second bridge segments 312 is spaced apart from an adjacent one of the second bridge segments 312 by a distance between the first piece of fabric 310 and the second piece of fabric 320. In addition, in another embodiment, the weaving structure of the first piece of fabric 310 could include a fourth warp yarn, and the second bridge segments 312 could be formed from the fourth warp yarn, as mentioned above. We are not going to describe the details again herein.

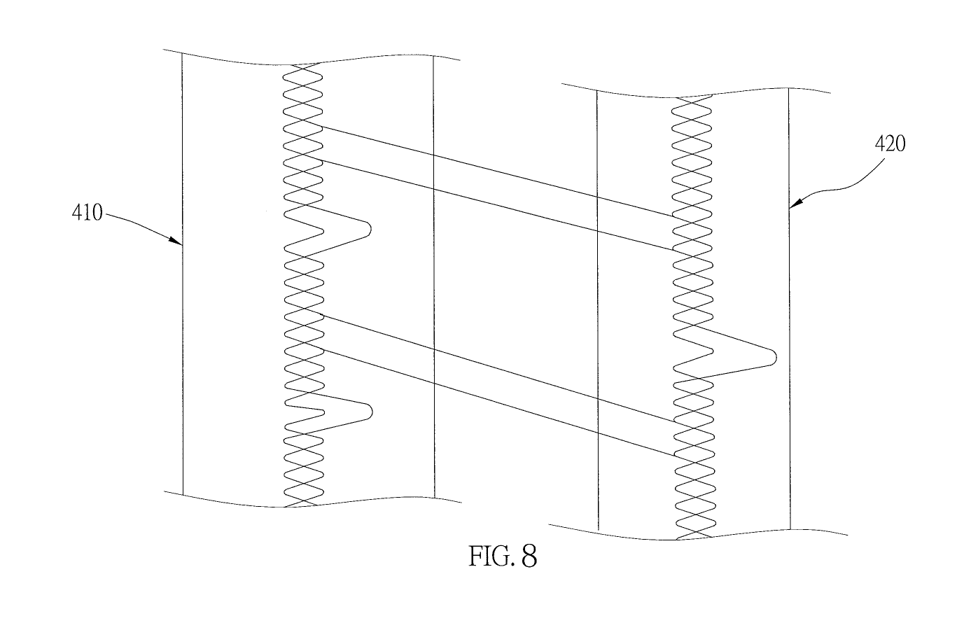

Particular features of the current embodiment include that, the first vertical member is the second piece of fabric 320, and said ring members include a plurality of first loop segments provided in a longitudinal axial direction of the second piece of fabric 320. More specifically, each of the first loop segments is spaced apart from an adjacent one of the first loop segments by a distance. For instance, the second piece of fabric 320 are made by interweaving a plurality of second vertical yarns and a plurality of second horizontal yarns, wherein the second vertical yarns is provided in the longitudinal axial direction of the second piece of fabric 320, and the horizontal yarns are provided in a direction perpendicular to the longitudinal axial direction of the second piece of fabric 320. The second vertical yarns include a fifth warp yarn 322 in the current embodiment. However, the fifth warp yarn 322 is not limited to be one of the second vertical yarns. In other embodiments, the fifth warp yarn 322 could be a cord made of the second vertical yarns or other yarn materials. During the process of making the ladder tape 30, the fifth warp yarn 322, is pulled out to form a plurality of first loop segments 322a with a part of the fifth warp yarn 322 arranged in the weaving structure of the second piece of fabric 320. More specifically, the first loop segments 322a are arranged in the longitudinal axial direction of the second piece of fabric 320 to be passed through by the first cord, and each of the first loop segments 322a is spaced apart from an adjacent one of the first loop segments 322a by a distance. Whereby, the movable range and position of the first cord could be adequately restricted and positioned. In addition, said connectors include a plurality of first bridge segments provided from the fifth warp yarn. For example, in an embodiment, a plurality of first bridge segments 322b could be provided from the weaving structure of the fifth warp yarn 322. Each of the first bridge segments 322b respectively joins the second piece of fabric 320 and the first piece of fabric 310 with two ends thereof, and each of the first bridge segments 322b is spaced apart from an adjacent one of the first bridge segments 322b by a distance between the second piece of fabric 320 and the first piece of fabric 310. More specifically, said spaced arrangement of the first bridge segments 322b is presented between either the first warp yarn (or the third warp yarn) and the fifth warp yarn. Each of the first bridge segments 322b is adapted to have one of the slats resting thereon. A width of the first piece of fabric 310 and a width of the second piece of fabric 320 could be either equal or different. For instance, a third embodiment of the present disclosure, which is different from the aforementioned second embodiment, is illustrated in FIG. 8. As it can be seen, in the third embodiment, a width of a first piece of fabric 410 is greater than a width of a second piece of fabric 420. In addition, yet in another embodiment, a width of a first piece of fabric could be less than a width of a second piece of fabric, which is not limited by the above exemplifications.

Also, the loop segments and the bridge segments of said second piece of fabric could be made of different warp yarns. For example, in an embodiment, the weaving structure of said second piece of fabric could include a sixth warp yarn, and said connectors include a plurality of first bridge segments formed on the sixth warp yarn. Each of the first bridge segments respectively joins the second piece of fabric and the first piece of fabric with two ends thereof, and each of the first bridge segments is spaced apart from an adjacent one of the first bridge segments by a distance between the second piece of fabric and the first piece of fabric.

In addition, in each of the aforementioned embodiments which includes a first piece of fabric and a second piece of fabric, a through hole could be provided on each of the slats, and either the first cord or the second cord of said window blind passes through either the first loop segments or the second loop segments which go out from the corresponding through holes of the slats. Whereby, the position of one of the cords could be further effectively restricted, which could prevent said cord from being moved in a horizontal direction to a great extent, or from being pulled out to form loops.

It must be pointed out that the embodiments described above are only some preferred embodiments of the present disclosure. All equivalent structures which employ the concepts disclosed in this specification and the appended claims should fall within the scope of the present disclosure.

What is claimed is:

1. A ladder tape, comprising:
a first vertical member;
a second vertical member arranged in parallel with the first vertical member, and spaced apart from the first vertical member by a distance, wherein the second vertical member is a piece of fabric made by interweaving a plurality of first vertical yarns and a plurality of first horizontal yarns;
a plurality of connectors, wherein each of the connectors respectively joins the first vertical member and the second vertical member with two ends thereof; and
a plurality of ring members provided in a longitudinal axial direction of at least one of the first vertical member and the second vertical member.

2. The ladder tape of claim 1, wherein the first vertical member comprises a first warp yarn, and the second vertical member comprises a second warp yarn; the ring members comprise a plurality of first loop segments, wherein the first loop segments are formed by one of the first warp yarn and the second warp yarn.

3. The ladder tape of claim 2, wherein the ring members comprise a plurality of second loop segments, and the second loop segments are formed by the other one of the first warp yarn and the second warp yarn.

4. The ladder tape of claim 2, wherein the connectors comprise a plurality of first bridge segments provided on the first warp yarn; each of the first bridge segments respectively joins the first vertical member and the second vertical member with two ends thereof, and each of the first bridge segments is spaced apart from an adjacent one of the first bridge segments by a distance between the first vertical member and the second vertical member.

5. The ladder tape of claim 2, wherein the connectors comprise a plurality of second bridge segments provided from the second warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member.

6. The ladder tape of claim 2, wherein the first vertical member comprises a third warp yarn, and the connectors comprise a plurality of first bridge segments provided from the third warp yarn; each of the first bridge segments respectively joins the first vertical member and the second vertical member with two ends thereof, and each of the first bridge segments is spaced apart from an adjacent first bridge segments by a distance between the first vertical member and the second vertical member.

7. The ladder tape of claim 2, wherein the second vertical member comprises a fourth warp yarn, and the connectors comprise a plurality of second bridge segments provided from the fourth warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member.

8. The ladder tape of claim 3, wherein the connectors comprise a plurality of first bridge segments provided from the first warp yarn; each of the first bridge segments respectively joins the first vertical member and the second vertical member with two ends thereof, and each of the first bridge segments is spaced apart from an adjacent one of the first bridge segments by a distance between the first vertical member and the second vertical member.

9. The ladder tape of claim 3, wherein the connectors comprise a plurality of second bridge segments provided from the second warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member.

10. The ladder tape of claim 3, wherein the first vertical member comprises a third warp yarn, and the connectors comprise a plurality of first bridge segments provided from the third warp yarn; each of the first bridge segments respectively joins the first vertical member and the second vertical member with two ends thereof, and each of the first bridge segments is spaced apart from an adjacent first bridge segments by a distance between the first vertical member and the second vertical member.

11. The ladder tape of claim 3, wherein the second vertical member comprises a fourth warp yarn, and the connectors comprise a plurality of second bridge segments provided from the fourth warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member.

12. The ladder tape of claim 1, wherein the first vertical member is a cord spaced apart from the second vertical member.

13. The ladder tape of claim 1, wherein the first vertical member is a piece of fabric made by interweaving a plurality of second vertical yarns and a plurality of second horizontal yarns.

14. The ladder tape of claim 13, wherein a width of the first vertical member and a width of the second vertical member are equal.

15. The ladder tape of claim 13, wherein a width of the first vertical member and a width of the second vertical member are different from each other.

16. A window blind, comprising a headrail, a bottom rail, a plurality of slats horizontally provided between the headrail and the bottom rail, a ladder tape, and at least one cord, wherein the headrail and the bottom rail are connected by the ladder tape; the at least one cord is adapted to collect and expand the window blind; the window blind is characterized in that:
the ladder tape comprises:
a first vertical member;
a second vertical member, which is arranged in parallel with the first vertical member, and is spaced apart from the first vertical member by a distance, wherein the second vertical member is a piece of fabric made by interweaving a plurality of first vertical yarns and a plurality of first horizontal yarns;
a plurality of connectors, wherein each of the connectors respectively joins the first vertical member and the second vertical member with two ends thereof; and
a plurality of ring members, which are provided in a longitudinal axial direction of at least one of the first vertical member and the second vertical member.

17. The window blind of claim 16, wherein the first vertical member comprises a first warp yarn, and the second vertical member comprises a second warp yarn; the ring members comprise a plurality of first loop segments, wherein the first loop segments are formed by one of the first warp yarn and the second warp yarn; the at least one cord comprises a first cord passing through the first loop segments.

18. The window blind of claim 17, wherein the ring members comprise a plurality of second loop segments, and the second loop segments are formed by the other one of the first warp yarn and the second warp yarn; the at least one cord comprises a second cord passing through the second loop segments.

19. The window blind of claim 17, wherein each of the slats is provided with a through hole; the first cord passes through the first loop segments, wherein the first loop segments respectively pass through the through holes of the slats, and a portion of each of the first loop segments coming out from the corresponding through hole is passed through by the first cord.

20. The window blind of claim 18, wherein each of the slats is provided with a through hole; the second cord passes through the second loop segments, wherein the second loop segments respectively pass through the through holes of the slats, and a portion of each of the second loop segments coming out from the corresponding through hole is passed through by the second cord.

21. The window blind of claim 17, wherein the connectors comprise a plurality of first bridge segments provided from the first warp yarn; each of the first bridge segments respectively joins the first vertical member and the second vertical member with two ends thereof, and each of the first bridge segments is spaced apart from an adjacent one of the first bridge segments by a distance between the first vertical member and the second vertical member; each of the first bridge segments has one of the slats resting thereon.

22. The window blind of claim 17, wherein the connectors comprise a plurality of second bridge segments provided from the second warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member; each of the second bridge segments has one of the slats resting thereon.

23. The window blind of claim 17, wherein the first vertical member comprises a third warp yarn, and the connectors comprise a plurality of first bridge segments provided from the third warp yarn; each of the first bridge segments respectively joins the first vertical member and the second vertical member with two ends thereof, and each of the first bridge segments is spaced apart from an adjacent first bridge segments by a distance between the first vertical member and the second vertical member; each of the first bridge segments has one of the slats resting thereon.

24. The window blind of claim 17, wherein the second vertical member comprises a fourth warp yarn, and the connectors comprise a plurality of second bridge segments provided from the fourth warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member; each of the second bridge segments has one of the slats resting thereon.

25. The window blind of claim 18, wherein the connectors comprise a plurality of first bridge segments provided from the first warp yarn; each of the first bridge segments respectively joins the first vertical member and the second vertical member with two ends thereof, and each of the first bridge segments is spaced apart from an adjacent one of the first bridge segments by a distance between the first vertical member and the second vertical member; each of the first bridge segments has one of the slats resting thereon.

26. The window blind of claim 18, wherein the connectors comprise a plurality of second bridge segments provided from the second warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member; each of the second bridge segments has one of the slats resting thereon.

27. The window blind of claim 18, wherein the first vertical member comprises a third warp yarn, and the connectors comprise a plurality of first bridge segments provided from the third warp yarn; each of the first bridge segments respectively joins the first vertical member and the second vertical member with two ends thereof, and each of the first bridge segments is spaced apart from an adjacent first bridge segments by a distance between the first vertical member and the second vertical member; each of the first bridge segments has one of the slats resting thereon.

28. The window blind of claim 18, wherein the second vertical member comprises a fourth warp yarn, and the connectors comprise a plurality of second bridge segments provided from the fourth warp yarn; each of the second bridge segments respectively joins the second vertical member and the first vertical member with two ends thereof, and each of the second bridge segments is spaced apart from an adjacent one of the second bridge segments by a distance between the second vertical member and the first vertical member; each of the second bridge segments has one of the slats resting thereon.

29. The window blind of claim 16, wherein the first vertical member is a cord spaced apart from the second vertical member.

30. The window blind of claim 16, wherein the first vertical member is a piece of fabric made by interweaving a plurality of second vertical yarns and a plurality of second horizontal yarns.

31. The window blind of claim 30, wherein a width of the first vertical member and a width of the second vertical member are equal.

32. The window blind of claim 30, wherein a width of the first vertical member and a width of the second vertical member are different from each other.
